(19) United States
(12) Patent Application Publication
(10) Pub. No.: US 2017/0238531 A1
(43) Pub. Date: Aug. 24, 2017

(54) Animal Decoy Apparatus

(71) Applicant: Western Discovery, LLC, Colorado Springs, CO (US)

(72) Inventors: Hippoliete Marvin Clyncke, Boulder, CO (US); Matthew Lance Hallum, Colorado Springs, CO (US)

(73) Assignee: Western Discovery, LLC, Colorado Springs, CO (US)

(21) Appl. No.: 15/441,159

(22) Filed: Feb. 23, 2017

Related U.S. Application Data
(60) Provisional application No. 62/298,819, filed on Feb. 23, 2016.

(51) Int. Cl. A01M 31/06; E04H 15/62; E04H 12/22

(52) U.S. Cl. CPC A01M 31/06; E04H 12/2215; E04H 15/62

(57) ABSTRACT

An animal decoy apparatus comprises a stake that can be driven into the ground; wherein the stake has a channel opening therein; a decoy wire assembly inserted into the channel opening of the stake; and a decoy mounted on the decoy wire assembly; wherein the decoy may freely and bi-directionally horizontally rotate 360° about the decoy wire assembly and of the decoy wire assembly may freely and bi-directionally horizontally rotate 360° about the stake. The channel opening in the stake allows the decoy wire assembly to freely and bi-directionally horizontally rotate 360° about the stake and allows a limited vertical orbital rotation of the decoy wire assembly in relation to the stake in a range of motion of equal to or less than 90°. The apparatus is kinetic and requires minimal wind energy to set it in motion, wherein the decoy will pivot about and bob up and down in relation to the decoy wire assembly and the stake to mimic the natural motion of an animal.

### CROSS-REFERENCE TO RELATED APPLICATION

This application claims the benefit of priority under 35 U.S.C. §119(e) from U.S. Provisional Application Ser. No. 62/298,819 filed Feb. 23, 2016, titled “Animal Decoy Apparatus” and the entire contents of which are incorporated by reference herein and should be considered a part of this specification.

### BACKGROUND OF THE INVENTION

Field of the Invention

The invention relates to an animal decoy apparatus.

Description of Related Art Including Information Disclosed Under 37 CFR 1.97 and 37 CFR 1.98

Decoys have been used for centuries to attract an animal being hunted. Decoys for use with hunting animals, such as game and fowl, are known.

U.S. Pat. No. 6,481,147 issued Nov. 19, 2002, by Lindaman for “Hunting Decoy Assemblies” discloses a decoy assembly for a turkey or other decoy has an animal decoy body that can be a collapsible hollow form with an expander. The body is carried on a mounting that is adjustable in height, has a nodding feature by which the body can bow forwardly and aft, and also can rotate over a span that is limited to less than a full revolution. Several alternative arrangements are provided. The mounting can have a bladelike strip having a substantially greater width than thickness, fitted to the body and rotatable in a hollow tubular section of the ground engaging stake part. The ground engaging part can have a radial inward crease that acts as an angular stop. The strip is preferably a spring and is aligned such that its greater width is lateral to the decoy body. Flexing of the body on the strip causes a fore-and-aft bobbing motion. According to alternatives, the mounting has telescoping tubes wherein a lateral pin through one interacts with an opening or a cam shaped end or a protrusion on the end of the other for limiting the rotation angle. The limited angular rotation and bobbing provide motions that are simulative of live animals and appear less artificial than unlimited free rotation, free bobbing in any direction and other potential motions.

U.S. Pat. No. 6,658,782 issued Dec. 9, 2003, by Brint for “Animated Decoys” discloses animated decoys each having a flexible decoy body which is supported on a self-contained decoy movement device that imparts life-like movement to the decoy body. In a first preferred embodiment, the decoy body is formed of a flexible sheet material such as rubber or foam rubber, typically in the two-dimensional shape of a fowl, and includes an opening which inserts on a cylindrical collar provided on the decoy movement device. The decoy movement device is supported on the upper end of a tapered spring which is provided on the upper end of an elongated, flexible support rod, the lower end of which support rod is typically inserted in the ground. The tapered spring permits life-like feeding or swimming movements of the decoy body imparted by the decoy movement device to attract predators or other fowl for photography, observation or hunting purposes. In a second embodiment, the decoy body is constructed in the three-dimensional size and shape of a turkey, hen, deer or other fowl or mammal and includes an interior pocket or pockets for receiving respective decoy movement devices which impart life-like motions to the decoy body.

U.S. Pat. No. 7,137,221 issued Nov. 21, 2006, by Highby et al. for “Spinning Decoy Device” discloses a spinning decoy device for use by hunters to attract birds, such as ducks and geese, has at least one decoy deployed in an elevated position, and a motorized system for spinning the decoy(s) so as to attract the birds. The motorized system, in a preferred embodiment, spins the decoy(s) in a circular motion. To further add realism to the device, the wings of each decoy are rotatable.

U.S. Pat. No. 7,493,723 issued Feb. 24, 2009, by Hess for “Decoy Apparatus” discloses a decoy apparatus adapted for spontaneous and continuous movement in response to the wind and other external stimuli, the decoy apparatus includes a body and a head, the body includes an upper torso aperture aligned with a lower torso, and an open front end having at least one body slot. An end of the head includes at least one pivot connector designed to releasably connect with one of the at least one body slots. The end of the head further includes a counterweight sized and positioned to balance the head with the body. The decoy further includes a support stake that is received through the upper torso aperture, passes through the body of the decoy, and extends through the lower torso aperture. A lower end of the stake defines a shovel portion that in application, is received in the ground surface. An upper end of the stake includes a slot used as an attachment point for a body harness. The body further includes at least a pair of apertures preferably disposed at lower ends of the body, the pair of apertures are further used as attachment points for the body harness. The body harness is centrally connected between the slot in the stake and each of the pair of apertures in the body.

U.S. Pat. No. 7,562,487 issued Jul. 21, 2009, by Barr for “Decoy Movement System for Simulating Life-Like Movement of Animal Species” discloses a decoy mounting and movement system for mounting a hollow animal species decoy and for simulating life-like movement of the animal species between a rest position and a vertically pivoted position which simulates feeding by the animal species having a decoy mounting stake formed of an elongate upper stake section and an elongate lower stake section interconnected via an elongate vertical return spring capable of bending along its length to create an angle between the upper and lower stake sections, the upper stake section dimensioned for insertion into the hollow of the decoy through an opening in its underside in communication with the hollow of the decoy, wherein the fulcrum for vertical pivoting of the decoy is positioned at the lower end of the upper stake section and the ratio D′/D is less than 0.25, wherein D′ is the distance between the underside of the decoy and the fulcrum for vertical pivoting, and D is the length of the upper stake section.

U.S. Pat. No. 8,316,575 issued Nov. 27, 2012, by Bradley for “Swivel Mount for Bird-Shaped Decoys” discloses a bird-shaped decoy that is supported on a swivel that is supported on a tubular component which allows the decoy to rotate. A bird-shaped decoy is mounted on a first swivel and a second swivel is mounted on a tubular component. An offset support rod connects the two swivels allowing the decoy to simultaneously orbit or rotate. The tubular component mounted swivel can have multiple support rods mounted thereon each extending to a swivel that supports a bird-shaped decoy.

U.S. Pat. No. 8,893,426 issued Nov. 25, 2014, by Jaeger for “Apparatus and Method for Using Waterfowl Decoys on Land” discloses an apparatus and a method for supporting a movable or stationary decoy displayed on a stake for attracting waterfowl where the decoy has a neck portion, a head portion, a body portion, and a stake that protrudes from and may be securely attached to the body portion of the decoy. A tubular receiving member having an internal channel is provided for loosely receiving the stake. The tubular receiving member can be made of black PVC conduit or other suitable materials and has an upper end that is flared to provide an opening that is larger than the internal channel in the tubular receiving member and a lower end that is sealed to prevent water from entering the tubular receiving member. The lower end of the tubular receiving member is adapted to be mounted in the ground.

US Patent Application 2002/0100206 published Aug. 1, 2002, by Brint for “Animated Decoys” discloses animated decoys each having a flexible decoy body which is supported on a self-contained decoy movement device that imparts life-like movement to the decoy body. In a first preferred embodiment, the decoy body is formed of a flexible sheet material such as rubber or foam rubber, typically in the two-dimensional shape of a fowl, and includes an opening which inserts on a cylindrical collar provided on the decoy movement device. The decoy movement device is supported on the upper end of a tapered spring which is provided on the upper end of an elongated, flexible support rod, the lower end of which support rod is typically inserted in the ground. The tapered spring permits life-like feeding or swimming movements of the decoy body imparted by the decoy movement device to attract predators or other fowl for photography, observation or hunting purposes. In a second embodiment, the decoy body is constructed in the three-dimensional size and shape of a turkey, hen, deer or other fowl or mammal and includes an interior pocket or pockets for receiving respective decoy movement devices which impart life-like motions to the decoy body.

US Patent Application 2006/0143970 published Jul. 6, 2006, by Lindaman for “Stake for a Decoy” discloses a hunting decoy structured for lifelike motion in the field by way of a flexible and limited rotational portion provided in a stake assembly that permits the decoy body to move relative to its resting position when force is applied to the decoy, such as through wind. A variety of mounts are provided to secure the stake assembly to the body of the decoy through springs, flanges, eccentric protrusions and fasteners.

US Patent Application 2008/0029659 published Feb. 7, 2008, by Weber et al. for “Universal Motion Master #3” discloses a decoy stand for attachment to a duck decoy which includes an attachment member to attach the decoy stand to the duck decoy, a bias member to variably bias the attachment member, a stake member to variably bias the attachment member, a tapered stopper member positioned on the stake member to change the bias of the attachment member and a stand mounting member to allow the decoy stand to be mounted in the ground. The decoy stand includes a receiver member to cooperate with the tapered stopper member, and the bias member includes a spring or elastic material. The decoy stand includes a connecting member to connect to the biasing member to the receiver member, and the decoy stand includes a top sleeve member to connect to the attachment member. The decoy stand includes a bottom sleeve member to attach to the stake member, and the stake member varies from straight to Z shaped.

US Patent Application 2009/0007479 published Jan. 8, 2009, by Jerome, SR., for “Manually Activated Rotatable Decoy Stake” discloses a decoy stake designed to support and impart motion to an animal decoy. The stake is preferably removably attached to a decoy and is controlled directly by a human observer through a simple mechanism such as a string, wire, or filament coupled to a rotatable mechanism contained within the stake. Preferably, the rotation mechanism is biased so that it returns to a determined rotational position when no force is applied by the operator. The invention further provides a method of attracting an animal using a manually rotatable decoy stake. The method includes attaching a decoy to the rotatable stake, placing the stake and attached decoy in a location where it is likely to be observed by the animal, and manually rotating the stake from a concealed location to impart rotational movement to the decoy.

US Patent Application 2013/0283664 published Oct. 31, 2013, by Kelly for “Wind-Activated Bird Decoy” discloses a bird decoy, such as the kind used for hunting, includes a body and head representative of the type of bird (e.g., goose, duck, turkey, etc.) being decoyed. The head is removably attached to a body. A wind rotation mechanism is inserted into the ground to support the decoy. The wind rotation mechanism can be attached to the head of the decoy and can include a shaft rotatably inserted into a tube. A tether can connect the decoy to a stake in the ground to constrain movement of the decoy. A set of such decoys includes a plurality of decoy bodies nested together in a stack.

### BRIEF SUMMARY OF THE INVENTION

An animal decoy apparatus of the present invention comprises a stake that can be driven into the ground; wherein the stake has a channel opening therein; a decoy wire assembly inserted into the channel opening of the stake; and a decoy mounted on the decoy wire assembly; wherein the decoy may freely and bi-directionally horizontally rotate 360° about the decoy wire assembly and the decoy wire assembly may freely and bi-directionally horizontally rotate 360° about the stake. The decoy wire assembly is able to freely and bi-directionally horizontally rotate 360° about the stake and has a limited vertical orbital rotation in relation to the stake in a range of motion of equal to or less than 90°.

### BRIEF DESCRIPTION OF THE SEVERAL VIEWS OF THE DRAWING(S)

FIG. 1 is a side plan view of an animal decoy apparatus of the present invention.

FIG. 2 is a top plan view of an animal decoy.

FIG. 3 is a bottom plan view of an animal decoy.

FIG. 4 is a plan view of a first embodiment of a stake and a decoy wire assembly.

FIG. 5 is a plan view of a second embodiment of a stake and a decoy wire assembly.

FIG. 6 is a plan view of a third embodiment of a stake and a decoy wire assembly.

FIG. 7 is another plan view of a first embodiment of a stake and a decoy wire assembly.

FIG. 8 is a plan view of a fourth embodiment of a stake and a decoy wire assembly.

List of Reference Numerals

2 apparatus

4 stake

6 stake channel opening

8 decoy wire assembly

10 decoy wire assembly first radius angle

12 decoy wire assembly second radius angle

14 stake cross bar

16 decoy wire assembly stop means

18 decoy wire assembly first length

20 decoy wire assembly second length

22 decoy wire assembly third length

24 decoy

26 decoy opening

28 decoy attachment means

30 pivot point

32 stake stabilizer leg

### DETAILED DESCRIPTION OF THE INVENTION

The animal decoy apparatus of the present invention may be adapted for use with any game or fowl. However, the preferred embodiment disclosed is for use of the apparatus with a turkey or other fowl decoy.

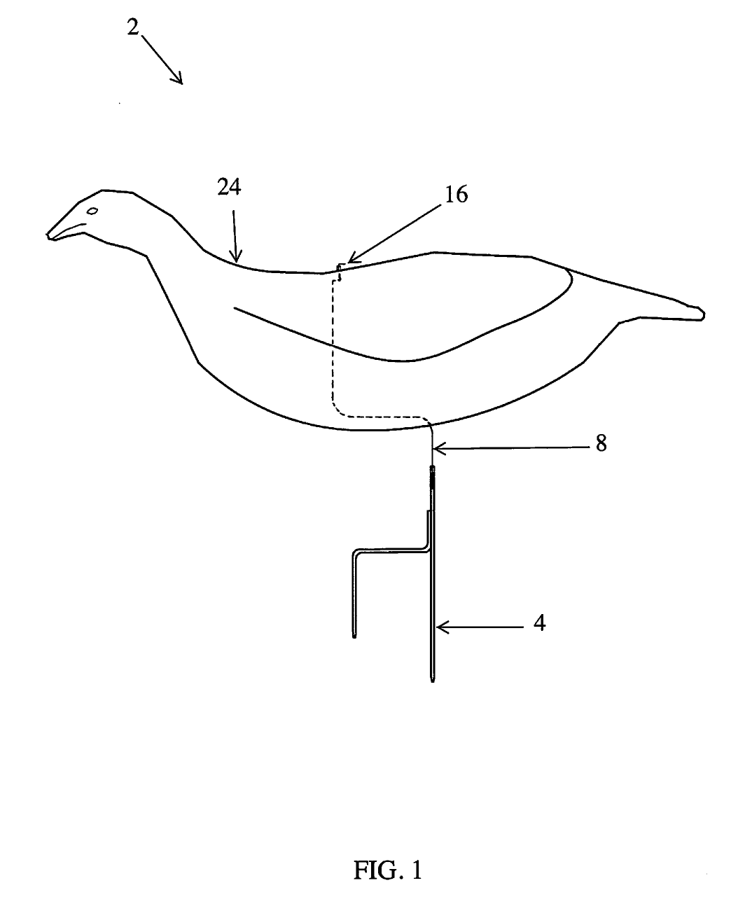

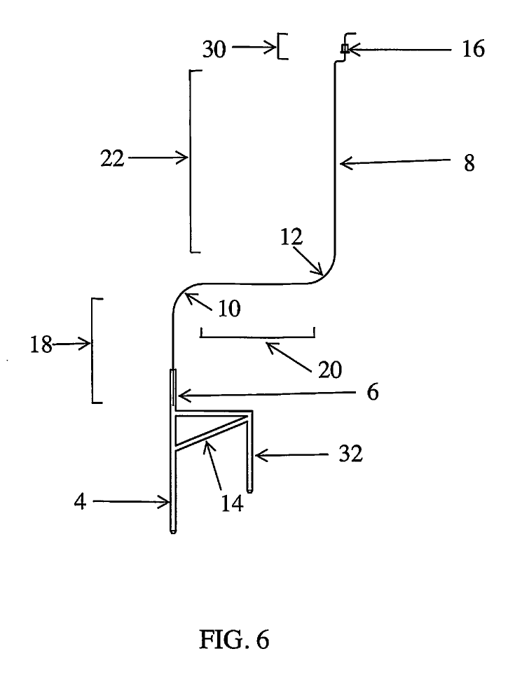

With reference to FIGS. 1, 7 and 8, to assemble an animal decoy apparatus 2 of the present invention, a stake 4 is driven or mounted into the ground to secure the stake in place, while having from about 2.5″ to about 5.0″ of the stake exposed above ground. A decoy wire assembly 8 is inserted into a stake channel opening 6. A decoy 24 is placed upon the decoy wire assembly 8. Dashed lines used in FIGS. 1-8, such as portions of the decoy wire assembly 8 and the stake channel opening 6, are to indicate internal features or environment.

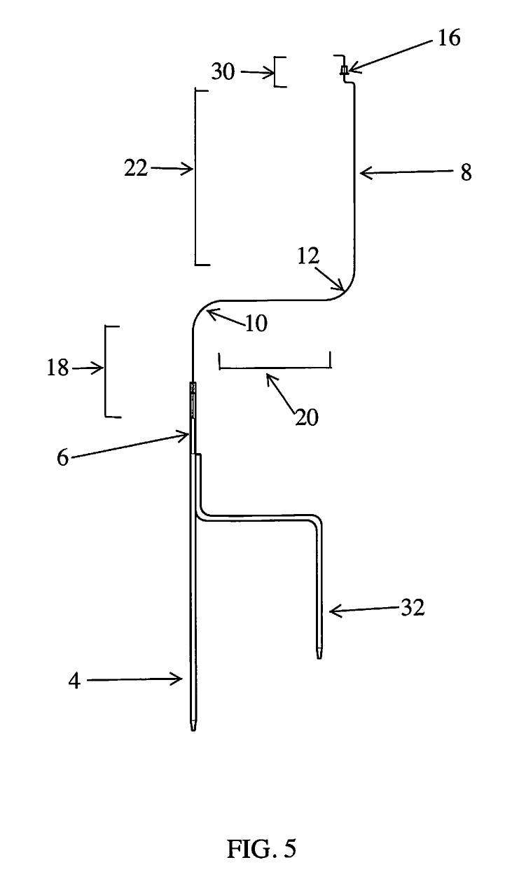

As shown in FIGS. 5-8 there are different embodiments of a decoy wire assembly 8 and a stake 4 of the animal decoy apparatus 2 of the present invention. The decoy wire assembly 8 preferably is made of wire from at least about 12 gauge to about 20 gauge. Suitable metals for the wire are any metals with sufficient resilience to allow the wire to function in a spring-like manner, such as copper, aluminum, steel and the like.

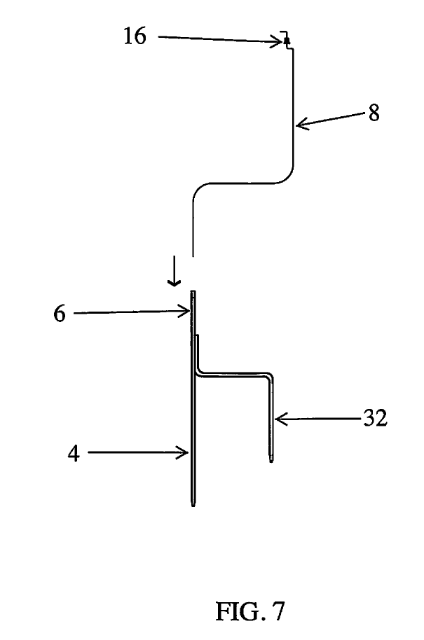

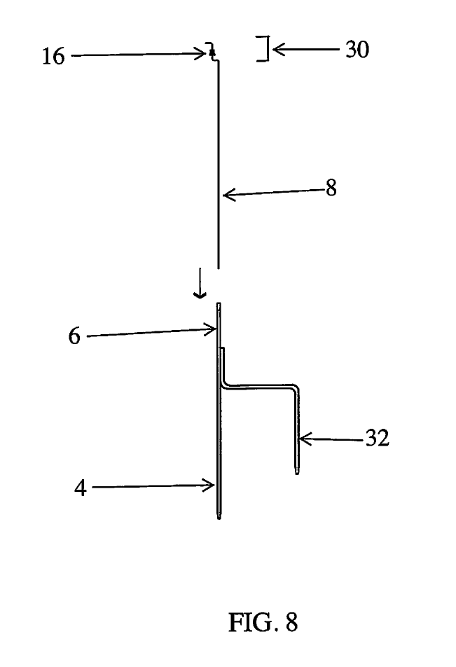

With reference to FIGS. 5-8, the decoy wire assembly 8 has a first length 18, a second length 20 and a third length 22; however, as shown in FIG. 8, the first length 18, the second length 20 and the third length 22 of the decoy wire assembly 8 is a single, contiguous length which serves the combined purposes, as discussed below, of each of the first length 18, the second length 20 and the third length 22. The first length 18 is engaged with a stake 4 as shown in FIGS. 7 and 8 by means of insertion of first length 18 with a stake channel opening 6. The depth of the stake channel opening 6 is from about 1.25″ to about 1.75″ in depth to accommodate and securely but releasably engage the first length 18 in stake channel opening 6, which stake channel opening 6 is from about 0.125″ to about 1.25″ in diameter to be able to accommodate the diameter of the decoy wire assembly 8. The decoy wire assembly 8 is removably inserted into the stake channel opening 6 and is able to rotate freely 360° in a horizontal orbital manner in either a clockwise or a counterclockwise direction about the stake 4 and within the stake channel opening 6.

The second length 20 of the decoy wire assembly 8 allows the decoy 24 to rotate freely 360° in a horizontal orbital manner in either a clockwise or a counterclockwise direction about the decoy wire assembly 8. With reference to FIGS. 1-3, a decoy receiving opening 26 allows the decoy 24 and decoy wire assembly 8 to rotate independently of each other without restriction or interference with each other.

With reference to FIGS. 1-8, the third length 22 of the decoy wire assembly 8 supports the decoy 24 upon the decoy wire assembly 8. At a terminal end of the third length 22 of the decoy wire assembly 8 is a decoy stop means 16, such as a bushing, to support the decoy 24 on the decoy wire assembly 8, but which allows the decoy 24 to rotate freely about the decoy wire assembly 8. The terminal end of the third length 22 of the decoy wire assembly 8 engages with a decoy attachment means 28, such as an opening with a grommet, but which allows the decoy 24 to rotate freely about the decoy wire assembly 8.

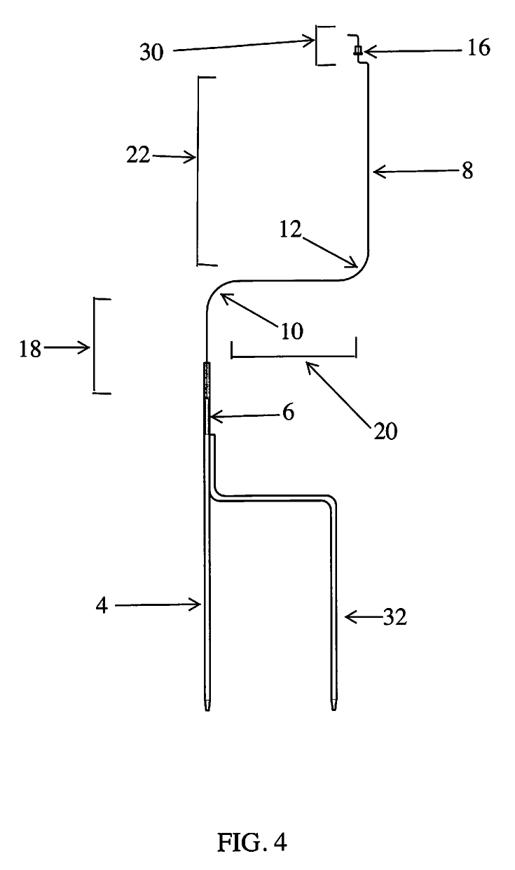

As shown in FIGS. 4-8, decoy wire assembly 8 has a pivot point 30 at a top end of the decoy wire assembly 8 which pivot point also receives the decoy wire assembly stop means 16 and engages with the decoy attachment means 28. The pivot point 30 has a bend in it at its top end to attach securely to the decoy 24 at the decoy attachment means 28.

With reference to FIGS. 1-8, the third length 22 of the decoy wire assembly 8 also allows the decoy to rotate in a vertical orbital manner about the decoy wire assembly 8 in a range of motion equal to or less than 90° in either in either a clockwise or a counterclockwise direction. This rotation allows the decoy 24 to mimic the natural up and down vertical motion of an animal, such as a body and a head bobbing motion of a turkey or other fowl.

With reference to FIGS. 4-6, the decoy wire assembly 8 has a first radius angle 10 and a second radius angle 12. The first radius angle 10 is interposed between the first length 18 and the second length 20, and the second radius angle 12 is interposed between the second length 20 and the third length 22. The first radius angle 10 and the second radius angle 12 are preferably from about 90° to about 130° and open in opposite directions from each other. The radius angles may be arced or angular. The first radius angle 10 and the second radius angle 12 provide resiliency to the decoy wire assembly 8 and allow it function in a spring-like manner so that the animal decoy apparatus 2 of the present invention may best mimic the natural movement of an animal.

The curvature of the angles 10, 12 which angles 10, 12 may be curved or strictly planar, allows for free, bi-directional 360° rotation of the decoy 24 to rotate about the decoy wire assembly 8 and of the decoy wire assembly 8 about the stake 4. Curved angles, such as shown by the first radius angle 10 and the second radius angle 12, allow for more bobbing action and realistic movement of the decoy 24, as compared to planar angles. Additionally, the curvature of the angles 10, 12 may be adjusted as necessary to obtain a desired rotational ability of the animal decoy apparatus 2 of the present invention for a weight and balance of any particular animal decoy 24.

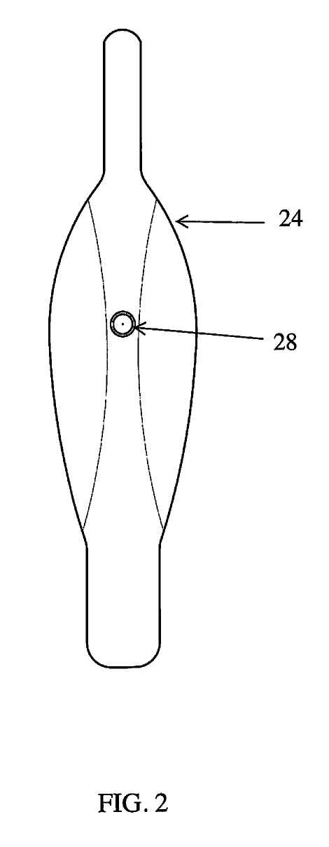

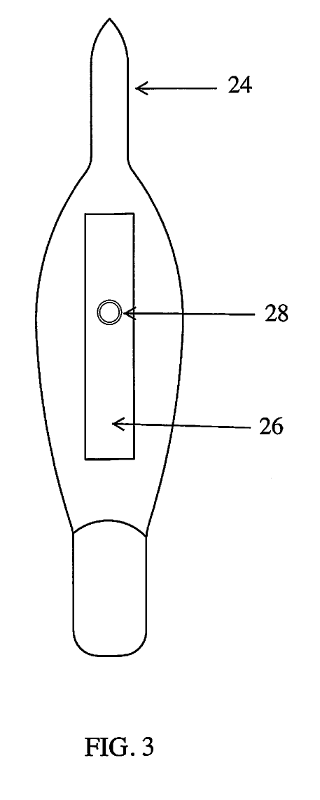

With reference to FIGS. 2 and 3, a decoy 24 of the present invention is shown having a decoy attachment means 28 for engaging with a decoy wire assembly stop means 16 and pivot point 30.

With reference to FIG. 3, a decoy 24 of the present invention is shown having a decoy attachment means 28, and a decoy opening 26 for receiving a decoy wire assembly 8.

With reference to FIGS. 4-8, a stake 4 of the animal decoy apparatus 2 of the present invention is shown. As also shown in FIGS. 7 and 8, the stake 4 has a stake channel opening 6 therein for receiving (as indicated by the unlabeled downward directional arrow) the decoy wire assembly 8. The stake channel opening 6 may be a smooth slot or may optionally have threads to secure a decoy wire assembly 8 therein and need be only of sufficient diameter and depth to receive and retain the decoy wire assembly 8 within the stake channel opening 6. The stake 4 may be any stake that may be configured to be driven into the ground stably and securely.

With reference to FIGS. 4-8, the stake 4 may have an optional stake stabilizer leg 32 which is integral with the stake 4 and provides not only a surface with which a user may drive the stake 4 into the ground such as by stepping on a portion of the stabilizer leg 32 that is parallel to the ground; but also further the portion of the stabilizer leg 32 that is parallel to the ground serves as a stop means to prevent the stake 4 from inadvertently being driven completely below the ground. When the stake 4 is in the ground, a portion of the stake stabilizer leg 32 which would be below ground may be either of equal or unequal length to a portion of the stake 4 that is also below ground. The stake 4 and the stake stabilizer leg 32 may have an optional stake cross bar 14 that not only further assists with strength and stability of the stake 4 when it is mounted in the ground, but also further serves as a stop means to prevent the stake 4 from inadvertently being driven completely below the ground.

With reference to FIG. 1, an animal decoy apparatus 2 of the present invention is shown. The decoy 24 is placed upon the decoy wire assembly 8 which is engaged with the stake 4.

As assembled and in use, the decoy 24 of the animal decoy apparatus 2 of the present invention will be set in motion by a minimal wind force. Optionally, the decoy 24 could be set in motion with a movement initiation means (not shown), by applying a manual force to the decoy 24, such as by a push with a hand or with an object; or, alternatively, by a pull with an optional device, such as a string, stick or wire, attached to the decoy 24 and which device could be operated from afar by a user without alerting an animal to the user's presence. Once the decoy 24 is in motion, the decoy 24 will pivot about and bob upon and down in relation to the decoy wire assembly 8 and the stake 4 to mimic the natural motion of an animal, such as a turkey.

The decoy 24 in a preferred embodiment may be made of foam, such as XPE foam, rubber or plastic, and patterned to resemble a male or female of a desired species of animal, such as a male or female turkey. Collapsible foam allows for the decoy 24 to be packed in minimal space, easily transported and quickly set up with the animal decoy apparatus 2 of the present invention.

Unless defined otherwise, all technical and scientific terms used herein have the same meaning as commonly understood by one of ordinary skill in the art to which this invention belongs. Although the present invention has been described with reference to preferred or specific embodiments, it is understood that modifications and variations of the present invention are possible without departing from the scope of the invention, which is defined by the claims set forth below.

The invention claimed is:

1. An animal decoy apparatus comprising:
a. A stake that can be driven into the ground; wherein the stake has a channel opening therein; and
b. A decoy wire assembly inserted into the channel opening of the stake;
wherein a decoy may be mounted upon the decoy wire assembly and the mounted decoy may freely and bi-directionally horizontally rotate 360° about the decoy wire assembly; and
further wherein the decoy wire assembly may freely and bi-directionally horizontally rotate 360° about the stake.

2. The apparatus of claim 1 further wherein the decoy wire assembly has a limited vertical orbital rotation in relation to the stake in a range of motion of equal to or less than 90°.

3. The apparatus of claim 1 further wherein the decoy wire assembly comprises a first length, a second length, and a third length; wherein the first length is removably engaged with the stake, the second length allows the decoy to rotate freely 360° in a horizontal orbital manner about the decoy wire assembly, and the third length supports the decoy upon the decoy wire assembly and allows the decoy to rotate in a vertical orbital manner about the decoy wire assembly.

4. The apparatus of claim 3 further wherein the decoy wire assembly comprises a first radius angle interposed between the first length and the second length, and a second radius angle interposed between the second length and the third length; wherein the first radius angle and the second radius angle open in opposite directions from each other.

5. The apparatus of claim 3 wherein the decoy wire assembly further comprises at a terminal end of the third length a decoy stop means and a pivot point.

6. The apparatus of claim 5 wherein the decoy further comprises a decoy attachment means; further wherein the decoy attachment means engages with the decoy stop means and the pivot point.

7. The apparatus of claim 1 further comprising a stabilizer leg integral with the stake.

8. The apparatus of claim 7 further comprising a cross bar integral with both the stabilizer leg and the stake.

9. An animal decoy apparatus comprising:
a. A stake that can be driven into the ground; wherein the stake has a channel opening therein; and
b. A decoy wire assembly inserted into the channel opening of the stake;
wherein a decoy may be mounted upon the decoy wire assembly and the mounted decoy may freely and bi-directionally horizontally rotate 360° about the decoy wire assembly;
further wherein the decoy wire assembly may freely and bi-directionally horizontally rotate 360° about the stake; and
further wherein the decoy wire assembly has a limited vertical orbital rotation in relation to the stake in a range of motion of equal to or less than 90°.

10. The apparatus of claim 9 further wherein the decoy wire assembly comprises a first length, a second length, and a third length; wherein the first length is removably engaged with the stake, the second length allows the decoy to rotate freely 360° in a horizontal orbital manner about the decoy wire assembly, and the third length supports the decoy upon the decoy wire assembly and allows the decoy to rotate in a vertical orbital manner about the decoy wire assembly.

11. The apparatus of claim 10 further wherein the decoy wire assembly comprises a first radius angle interposed between the first length and the second length, and a second radius angle interposed between the second length and the third length; wherein the first radius angle and the second radius angle open in opposite directions from each other.

12. The apparatus of claim 10 wherein the decoy wire assembly further comprises at a terminal end of the third length a decoy stop means and a pivot point.

13. The apparatus of claim 12 wherein the decoy further comprises a decoy attachment means; further wherein the decoy attachment means engages with the decoy stop means and the pivot point.

14. The apparatus of claim 9 further comprising a stabilizer leg integral with the stake.

15. The apparatus of claim 14 further comprising a cross bar integral with both the stabilizer leg and the stake.

16. An animal decoy apparatus comprising:
a. A stake that can be driven into the ground; wherein the stake has a channel opening therein; and
b. A decoy wire assembly inserted into the channel opening of the stake;
wherein a decoy may be mounted upon the decoy wire assembly and the mounted decoy may freely and bi-directionally horizontally rotate 360° about the decoy wire assembly;
further wherein the decoy wire assembly may freely and bi-directionally horizontally rotate 360° about the stake;
further wherein the decoy wire assembly has a limited vertical orbital rotation in relation to the stake in a range of motion of equal to or less than 90°;
further wherein the decoy wire assembly comprises a first length, a second length, and a third length; wherein the first length is removably engaged with the stake, the second length allows the decoy to rotate freely 360° in a horizontal orbital manner about the decoy wire assembly, and the third length supports the decoy upon the decoy wire assembly and allows the decoy to rotate in a vertical orbital manner about the decoy wire assembly;
further wherein the decoy wire assembly further comprises at a terminal end of the third length a decoy stop means and a pivot point; and
further wherein the decoy further comprises a decoy attachment means; wherein the decoy attachment means engages with the decoy stop means and the pivot point.

17. The apparatus of claim 16 further wherein the decoy wire assembly comprises a first radius angle interposed between the first length and the second length, and a second radius angle interposed between the second length and the third length; wherein the first radius angle and the second radius angle open in opposite directions from each other.

18. The apparatus of claim 16 further comprising a stabilizer leg integral with the stake.

19. The apparatus of claim 18 further comprising a cross bar integral with both the stabilizer leg and the stake.
